(19) United States
(12) Patent Application Publication
(10) Pub. No.: US 2012/0152286 A1
(43) Pub. Date: Jun. 21, 2012

(54) CLEANING AGENT FOR REMOVAL OF SOLDERING FLUX

(75) Inventors: Kyle J. Doyel, Franklin, TN (US); Michael L. Bixenman, Old Hickory, TN (US); David T. Lober, Franklin, TN (US); Wayne Raney, White House, TN (US); Kevin Soucy, Nashville, TN (US)

(73) Assignee: Kyzen Corporation, Nashville, TN (US)

(21) Appl. No.: 13/316,063

(22) Filed: Dec. 9, 2011

Related U.S. Application Data
(60) Provisional application No. 61/423,647, filed on Dec. 16, 2010.

(51) Int. Cl. B08B 3/00; C11D 7/60; C11D 3/60

(52) U.S. Cl. 134/26; 510/175

(57) ABSTRACT

A composition effective for removing solder fluxes either as a concentrated material or when diluted with water. The composition is effective in removing all types of solder fluxes including rosin type, resin type, no-clean, low residue, lead-free, organic acid and water soluble soldering fluxes. The composition comprises tripropylene glycol butyl ether and an alkali and has a pH of greater than 7.5. The composition may contain additional optional solvents and additives to enhance cleaning of articles or to impart other properties to the composition. The composition can be contacted with a surface to be cleaned in a number of ways and under a number of conditions depending on the manufacturing or processing variables present.

### CROSS-REFERENCE TO RELATED APPLICATION

This application claims the benefit of Provisional Application Ser. No. 61/423,647 filed Dec. 16, 2010.

### FIELD OF THE INVENTION

This invention related to a composition and method for removing solder flux.

### BACKGROUND

Solder is used in the manufacture of electronic parts, electronic assemblies, and equipment used in the manufacturing of electronic assemblies. This, inevitably, results in the deposition of solder flux, regardless of the type of solder used. Any and all of these components, assemblies, and equipment used in the manufacture of assemblies must be pristine clean in order to avoid malfunction at a later date.

### BRIEF SUMMARY OF THE INVENTION

According to the present invention, a composition is provided which is effective for removing solder flux either as a concentrated material or diluted with water. The composition is effective to remove, in a single step, all types of solder fluxes including, rosin type, resin type, no-clean, low residue, lead-free, organic acid and water soluble soldering fluxes. The composition exhibits excellent cleaning and rinsing properties with polar rinse agents such as water and alcohols. The composition comprises tripropylene glycol butyl ether (TPGBE) and an alkali and has a pH of at least about 7.5 and, preferably, greater than 7.5. Optionally the concentrated composition may have a secondary solvent system that is added with the TPGBE to make the total amount of solvent in the concentrated composition range from 0.01 to 99.99 weight percent, and preferably from 30 to 99.99% weight percent. Conversely the alkali may range from 0.01% to 70 weight percent. Optionally up to 10 percent, preferably up to 3 percent, of a non-ionic surfactant may be added to the concentrated composition to assist in cleaning efficacy. Optionally corrosion inhibitors, buffering agents, chelating agents and/or sequestrants my be added as would be known by one skilled in the art. The concentrated composition may be used neat (at 100%) or diluted with water to result in a concentration of the composition from 99.1 weight percent to 0.1 weight percent concentration of the concentrate composition. The dilution of the concentrate will allow use in multiple styles of cleaning machines. The concentration of the composition is an amount effective to dissolve, remove and clean soldering flux.

The present invention also contemplates a method of removing solder flux by contacting a substrate containing the solder flux in a single step with the composition of the invention. In this context, Asubstrate@ is defined as any electronic part, electronic assembly, or equipment used in the manufacturing of electronic assemblies.

### DETAILED DESCRIPTION OF THE INVENTION

In accordance with the invention, novel cleaning compositions have been formulated comprising TPGBE and one or more alkaline agents that render the pH of the concentrated cleaning composition greater than 7.5. Optionally, the composition contains one or more additional solvents, non-ionic surface active agents, corrosion inhibitors, chelation or sequestering agents, pH buffering agents, or agents that modify the foaming characteristics, as known by those skilled in the art. Each of these additives may comprise one agent or a mixture of agents in order to impart the desired characteristic to the final cleaning composition. The concentrated composition may be used neat (at 100%) or diluted with water to result in a concentration of the composition from 99.9 weight percent to 0.1 weight percent of the concentrate composition. The dilution of the concentrate will allow use in multiple styles of cleaning machines. The concentration of the composition is an amount effective to dissolve, remove, and clean soldering flux.

It is another important aspect of the present invention that the TPGBE forms an azeotrope with water at 1.0%. This results in a minimal loss of solvent due to evaporation during the cleaning process, even where ventilation creates a pressure differential over the liquid surface which ordinarily causes solvent evaporation.

The invention contemplates a concentrated liquid cleaning composition which comprises TPGBE and a sufficient amount of an alkali to result in a pH at least about 7.5. The composition may be diluted with water to a concentration of 0.1 to 99.1 wt %. In a preferred embodiment, the composition can be diluted with water to a concentration of about 30 to about 99.99%.

In another embodiment, the composition may contain at least one additional secondary solvent that imparts different solubility parameters for different flux types. The secondary solvent or solvents may be in the composition in a total amount of up to 90%, preferably up to 70%. The secondary solvent or solvents can be one or more of the following:

a glycol ether of the formula R₁—O—(CₓH₂ₓO)ₙ—H, wherein:
R₁ is an alkyl group having 1 to 6 carbon atoms,
n is integer from 1 to 4, and
x is integer from 1 to 4

an alcohol of the formula R₂—OH, wherein:
R₂ is an alkyl group having 1 to 8 carbon atoms, a tetrahydrofurfuryl group, a benzyl group or hydrogen

an N-alkyl pyrollidone of the formula R₃Npyrr, wherein:
Npyrr represents a pyrollidone ring
R₃ is an alkyl group having 1 to 8 carbon atoms

dibasic esters of the formula R₄—O—OC—(CH₂)ₖ—CO—O—R₄, wherein:
R₄ is Methyl, ethyl, or isobutyl
k is an integer from 2 to 4

The secondary solvent is selected from the group consisting of dipropylene glycol methyl ether, dipropylene glycol propyl ether, dipropylene glycol butyl ether, tripropylene glycol methyl ether, diethylene glycol butyl ether, methoxy methyl butanol, tetrahydrofurfuryl alcohol, benzyl alcohol, N-methylpyrollidone, N-ethyl pyrollidone, N-propyl pyrollidone, N-octyl pyrollidone, dimethyl adipate, dimethyl succinate, dimethyl glutarate, diisobutyl adipate, diisobutyl succinate and diisobutyl glutarate.

The alkali is one or more of an amine, imide, inorganic hydroxide, silicate, or phosphate and is present in an amount of 0.01 to 70 wt %.

The preferred amine is an alkanolamine.

The alkanolamine is selected from the group consisting of monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol and combinations thereof.

The inorganic salts are selected from the group consisting of sodium hydroxide, potassium hydroxide, sodium silicate, sodium metasilicate, potassium silicate, sodium phosphate, potassium phosphate and combinations thereof.

In an embodiment, one or more surface active agents are added to improve cleaning, or processing. It is preferred that the surface active agent is a nonionic surfactant. A typical nonionic surfactant is Trito™ X-100 which is produced from octylphenol polymerized with ethylene oxide. The nonionic surfactant is added in an amount less than 10% and preferably less than 3% of the weight of the composition.

One or more corrosion inhibitors may be added to the composition to improve compatibility. Preferred corrosion inhibitors are selected from the group consisting of benzotriazoles, derivatives of benzotriazoles, water soluble silicates, and inorganic salts of phosphoric acid. The preferred corrosion inhibitor is an alkali salt of a metasilicate.

One or more buffering agents may be added to provide pH control. Preferred buffering agents are selected from the group consisting of mono, di and tri-carboxylic acids. The preferred buffering agent is one or more of 2-hydroxypropane-1,2,3-tricarboxylic acid, C₃ to C₂₀ mono carboxylic acids, hydrogen alkali salts of phosphoric acid, and boric acid. The buffering agent is added an a concentration effective to keep the pH at least 7.5 and, preferably, above 7.5.

At least one chelating or sequestering agent may be added to the composition. Preferred chelation or sequestering agents are ethylenediaminetetraacetic acid (EDTA) or its salts and ethylenediamine-N,N═-disuccinic acid or its salts.

In another aspect of the invention, a method is provided which comprises a single stage wash with the composition in a manner known to those skilled in the art of cleaning. The wash is followed by a rinse stage to remove the composition from the part followed by a dry stage. Wash and rinse can be accomplished by means of spraying, spray under immersion, agitation, ultrasonics, dipping, tumbling, wiping or immersion. The wash may be conducted at ambient temperature or as low as 2 degrees C. below the flash point of the composition

Some embodiments are summarized in the following table:

TABLE

| | In 100% Required Concentrated | % Composition in |
|---|---|---|
| Required | Composition | Water |
| A) Solvent system content in | 30-99.99% | |
| concentrated liquid wt % | | |
| Tripropylene Glycol Butyl Ether | 9-100% | |
| (TPGBE) as wt % of total solvent | | |
| system | | |
| B) Alkaline Agent content in | .01-70% | |
| concentrated liquid wt % | | |
| (A + B) Solvent System plus | 30.01-100.00% | 0.1 to 100% (neat) |
| Alkaline agent in Concentrate wt | | |
| % | | |
| Optional Items in Concentrate wt | 0.00-69.99% | |
| % | | |
| Optional Solvent as wt % of | 0.00-91% | |
| solvent system | | |
| Optional Surface Active Agent | Effective Amt. | |
| Optional Non Ionic Surfactants | <3% | <3% |
| Optional Corrosion Inhibitors | Effective Amt. | |
| Optional Buffering Agents | Effective Amt. | |
| Optional Chelators Sequestrants | Effective Amt. | |
| Required pH | >7.5 | >7.5 |

Preferred embodiments of the composition and method of the present invention are described in detail in the following examples which should not be construed to limit the scope of the present invention. Unless stated otherwise, all parts and percentages are given by weight.

### Example 1

Solutions of TPGBE in water were made at 0.5%, 1.0%, and 3.0% TPGBE by weight. These solutions were distilled using a Snyder column and a condenser capable of returning the distillate to the boiling flask, through the Snyder column, or to a sampling port. The following samples of the distillate were taken: first distillate to condense, distillate after 15 minutes of reflux, and distillate after 30 minutes of reflux. The concentration of TPGBE was monitored at each point in time with two independent methods. The concentration of TPGBE in the distillate for all initial TPGBE concentrations at all points in time was 1.0% ∀0.2% (95% confidence interval) by weight. This indicates that TPGBE forms an azeotrope at 1.0%.

### Example 2

A concentrated cleaning agent was formulated with a composition of 82.0% TPGBE, 15.90% 2-aminoethanol, 0.1% citric acid, 2.2% Triton X-100, 0.2% disodium EDTA, 2.4% buffering agent consisting of C₃ to C₂₀ mono carboxylic acids and/or their alkali metal salts, with water comprising the balance. The pH of the neat cleaning agent was 11.5.

### Example 3

The concentrated cleaning agent described in Example 2 was diluted with water creating a solution that consisted of 5.0% of the concentrated cleaning agent by weight, and 95.0% water, by weight. This diluted composition was placed in an inline spray in air cleaning machine. Electronic assemblies were constructed with solder fluxes of the water soluble (WS), rosin mildly activated (RMA), rosin activated (RA) fluxes, and no clean (NC) types. These electronic assemblies were then cleaned in the diluted cleaning agent using a spray in air process for approximately four minutes at about 65.6E C (150E F). After cleaning, the electronic assemblies were evaluated for percentage of flux removed using visual inspection. Most electronic assemblies had complete (100%) flux removal.

### Example 4

The concentrated cleaning agent described in Example 2 was diluted to 8% by weight with water. Circuit assemblies of the same types described in Example 3 were cleaned in the exact same manner as in Example 3 but at temperatures of about 49E C (120E F), about 54.4E C (130E F), 60E C. (140E F), and about 65.6E C (150E F). The cleaning performance of the diluted cleaning agent was excellent at all temperatures.

### Example 5

A concentrated cleaning agent was formulated with a composition of 38.1% TPGBE, 37.9% dipropylene glycol n-propyl ether (DPnP), 14.6% 2-aminoethanol, 0.1% citric acid, 1.8% Triton X-100, 0.4% disodium EDTA, 2.0% buffering agent consisting of C₃ to C₂₀ mono carboxylic acids and/or their alkali metal salts, with water comprising the balance. The pH of the neat cleaning agent was 11.4.

### Example 6

The concentrated cleaning agent described in Example 5 was diluted to 8% by weight with water. Circuit assemblies of the same types described in Example 4 were cleaned in the exact same manner as in Example 4. The cleaning performance of the diluted cleaning agent was excellent at all temperatures.

### Example 7

A concentrated cleaning agent was formulated with a composition of 9.0% TPGBE, 64.5% dipropylene glycol n-propyl ether (DPnP), 15.9% 2-aminoethanol, 0.2% citric acid, 2.2% Triton 100, 0.4% disodium EDTA, 2.5% buffering agent consisting of C₃ to C₂₀ mono carboxylic acids and/or their alkali metal salts, with water comprising the balance. The pH of the neat cleaning agent was 11.3.

### Example 8

The concentrated cleaning agent described in Example 7 was diluted to 8% by weight with water. Circuit assemblies of the same types described in Example 4 were cleaned in the exact same manner as in Example 4. The cleaning performance of the diluted cleaning agent was excellent at all temperatures. The cleaning performance of the diluted cleaning agent was excellent at all temperatures.

### Example 9

A concentrated cleaning agent was formulated with a composition of 64.8% TPGBE, 9.0% dipropylene glycol n-propyl ether (DPnP), 16.0% 2-aminoethanol, 0.1% citric acid, 2.1% Triton X-100, 0.2% disodium EDTA, 2.4% buffering agent consisting of C₃ to C₂₀ mono carboxylic acids and/or their alkali metal salts, with water comprising the balance. The pH of the neat cleaning agent was 11.4.

### Example 10

The concentrated cleaning agent described in Example 9 was diluted to 8% by weight with water. Circuit assemblies of the same types described in Example 4 were cleaned in the exact same manner as in Example 4. The cleaning performance of the diluted cleaning agent was excellent at all temperatures. The cleaning performance of the diluted cleaning agent was excellent at all temperatures.

Various modifications and alterations of this invention will be apparent to those skilled in the art without departing from the scope and spirit of this invention. Unless stated otherwise, all parts and percentages in the following claims are given by weight.

What is claimed is:

1. A composition effective for removing solder flux in a single washing stage comprising tripropylene glycol butyl ether and an alkali and has a pH of at least about 7.5.

2. The composition of claim 1, further comprising water.

3. The composition of claim 2, wherein said water is present in an amount of about 99.9% to about 0.1%.

4. The composition of claim 1, further comprising a secondary solvent.

5. The composition of claim 4, wherein said secondary solvent is present in an amount up to about 90%.

6. The composition of claim 4, wherein the secondary solvent is a member of the group consisting of
a glycol ether of the formula R₁—O—(CₓH₂ₓO)ₙ—H, wherein:
R₁ is an alkyl group having 1 to 6 carbon atoms,
n is integer from 1 to 4, and
x is integer from 1 to 4;
an alcohol of the formula R₂—OH, wherein:
R₂ is an alkyl group having 1 to 8 carbon atoms, a tetrahydrofurfuryl group, a benzyl group or hydrogen;
an N-alkyl pyrollidone of the formula R₃Npyrr, wherein:
Npyrr represents a pyrollidone ring
R₃ is an alkyl group having 1 to 8 carbon atoms; and
a dibasic ester of the formula R₄—O—CO—(CH₂)ₖ—CO—O—R₄, wherein:
R₄ is Methyl, ethyl, or isobutyl
k is an integer from 2 to 4.
and mixtures thereof.

7. The composition of claim 6, wherein the secondary solvent is selected from the group consisting of: dipropylene glycol methyl ether, dipropylene glycol propyl ether, dipropylene glycol butyl ether, tripropylene glycol methyl ether, diethylene glycol butyl ether, methoxy methyl butanol, tetrahydrofurfuryl alcohol, benzyl alcohol, water, N-methylpyrollidone, N-ethyl pyrollidone, N-propyl pyrollidone, N-octyl pyrollidone, dimethyl adipate, dimethyl succinate, dimethyl glutarate, diisobutyl adipate, diisobutyl succinate and diisobutyl glutarate, and mixtures thereof.

8. The composition of claim 1, wherein the alkali is one or more of an amine, imide or inorganic alkaline salts, silicate or phosphate and is present in an amount of 0.01 to 70 weight percent.

9. The composition of claim 8 wherein the amine is an alkanolamine.

10. The composition of claim 9, wherein the alkanolamine is selected from the group consisting of monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol and combinations thereof.

11. The composition of claim 8, wherein the inorganic alkaline salts are selected from the group consisting of sodium hydroxide, potassium hydroxide, sodium silicate, sodium metasilicate, potassium silicate, sodium phosphate, potassium phosphate and combinations thereof, and mixtures thereof.

12. A composition of claim 1, wherein said tripropylene glycol butyl ether is present at a concentration of 0.1% to 99.99% and said alkali is present at a concentration of 0.01% to 90.00% to thereby render the pH greater than 7.5.

13. The composition of claim 1, further comprising a non ionic surface active agent.

14. The composition of claim 13, wherein said non ionic surface active agent is present in an amount of up to about 10%.

15. The composition of claim 14, wherein said non ionic surface active agent is present in an amount of up to about 3%.

16. The composition of claim 1, further comprising a corrosion inhibitor.

17. The composition of claim 16, wherein said corrosion inhibitor is selected from the group consisting of benzotriazoles, derivatives of benzotriazoles, water soluble silicates, inorganic salts of phosphoric acid, and mixtures thereof.

18. The composition of claim 17, wherein said corrosion inhibitor is an alkali salt of a metasilicate.

19. The composition of claim 1, further comprising a buffering agent.

20. The composition of claim 19, wherein said buffering agent is selected from the group consisting of mono, di and tri-carboxylic acids, and mixtures thereof.

21. The composition of claim 20, wherein said buffering agent is one or more of 2-hydroxypropane-1,2,3-tricarboxylic acid, C₃ to C₂₀ mono carboxylic acids, hydrogen alkali salts of phosphoric acid, and boric acid.

22. The composition of claim 19, wherein said buffering agent is present at a concentration effective to keep the pH at least 7.5.

23. The composition of claim 22, wherein said buffering agent is present at a concentration effective to keep the pH above 7.5.

24. The composition of claim 1, further including at least one chelating or sequestering agent.

25. The composition of claim 24, wherein said chelating or sequestering agent is selected from the group consisting of ethylenediaminetetraacetic acid or its salts and ethylenediamine-N,N═-disuccinic acid or its salts, and mixtures thereof.

26. The composition of claim 1, further including a foaming modifying agent.

27. A method of removing solder flux from a substrate comprising contacting said substrate with the composition of claim 1 in a single washing stage at a temperature and a contact time sufficient to remove said solder flux.

28. A method according to claim 27, wherein said washing stage is followed by a rinsing stage and a drying stage.
